(19) United States
(12) Patent Application Publication
(10) Pub. No.: US 2008/0087349 A1
(43) Pub. Date: Apr. 17, 2008

(54) Molded tube for vehicle fuel delivery module

(75) Inventor: Raymond Holtz, Auburn Hills, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/902,249

(22) Filed: Sep. 20, 2007

Related U.S. Application Data
(60) Provisional application No. 60/846,243, filed on Sep. 21, 2006.

(51) Int. Cl. B29D 23/00; B29C 45/00; F16L 11/00

(52) U.S. Cl. 138/118; 264/500

(57) ABSTRACT

A method provides a tube for a fuel delivery module. The tube (16) is preferably constructed and arranged to be fluidly coupled between a fuel filter and a fuel pump of the module. The method includes molding a hollow tube (16) including a first portion (18) and a second portion (24) integral with the first portion. Each of the first and second portions has an opened end (20, 26), with the opened ends communicating with each other. Each opened end has axis (A, B). The axis (B) of the opened end of the second portion is generally transverse with respect to the axis (A) of the opened end of the first portion. The method further includes pre-forming the tube such that the axis (B) of the opened end of the second portion is generally parallel with respect to the axis (A) of the opened end of the first portion, with the opened ends facing the same direction.

This application claims the benefit of the earlier filing date of U.S. Provisional Application No. 60/846,243, filed on Sep. 21, 2006, which is incorporated by reference herein in its entirety.

### FIELD OF THE INVENTION

This invention relates to a vehicle fuel delivery module and, more particularly, to a molded hollow tube for any hydraulic connection within a fuel delivery module.

### BACKGROUND OF THE INVENTION

In a conventional fuel delivery module for a vehicle, in order to package a pump and lifetime filter to the available or required height restricted space, an extruded pre-formed tube is used. With reference to FIG. 1, one such conventional tube 10 is show connected between barbs a fuel pump 12 and a filter 14. In order to achieve the smallest height with an extruded tube, manufacturing is difficult since there should be a smooth transition from one axis to the other (with the smallest possible bend radius). Furthermore, disadvantages of an extruded tube include: 1) end to end tolerances are hard to control, 2) axis to axis tolerances are hard to control, 3) straight length tolerances are large (as the extruded tube is being cut on the fly, causing the cut to be angled) and 4) no dedicated profile is provided for use in pushing the tube onto the barb geometry (as the extruded tube is completely smooth on the outside). All of these disadvantages make it very difficult to maintain the tolerances regarding how far the tube is pushed onto the barb geometry in production.

Thus, there is a need to provide a tube for a fuel delivery module that is molded, not extruded.

### SUMMARY OF THE INVENTION

An object of the invention is to fulfill the need referred to above. In accordance with the principles of the present invention, this objective is achieved by providing a molded hollow tube for a hydraulic connection in a fuel delivery module of a vehicle. The molded tube includes a first portion having an opened end and a closed end. The opened first end has an axis. A second portion is integral with the first portion. The second portion has an opened end and an end coupled with the first portion near the closed end of the first portion. The opened end of the second portion has an axis. The opened ends are in communication such that fuel can enter and exit the tube via the opened ends. The second portion includes at least one bend therein such that the axis of the opened end of the second portion is generally parallel with respect to the axis of the opened end of the first portion, with the opened ends facing the same direction.

In accordance with another aspect of the invention, a method of providing a tube for a fuel delivery module is provided. The method includes molding a hollow tube including a first portion and a second portion integral with the first portion. Each of the first and second portions has an opened end, with the opened ends communicating with each other. Each opened end has axis. The axis of the opened end of the second portion is generally transverse with respect to the axis of the opened end of the first portion. The method further includes pre-forming the tube such that the axis of the opened end of the second portion is generally parallel with respect to the axis of the opened end of the first portion, with the opened ends facing the same direction.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawing, in which:

FIG. 1 is a view of a conventional, extruded tube connected between a fuel pump and a fuel filter of a vehicle fuel delivery module.

FIG. 2 is an enlarged view of a tube for a fuel delivery module provided in accordance with an embodiment of the present invention.

FIG. 3 is a view of the tube of FIG. 2 pre-formed or bent into a first configuration.

FIG. 4 is a view of the pre-formed tube of FIG. 3 shown coupled between a fuel pump and a fuel filter of a fuel delivery module.

FIG. 5 is a side view of FIG. 4 showing the convention tube of FIG. 1 superimposed to indicate a height difference between the pre-formed tube of FIG. 4 and the conventional tube of FIG. 1.

FIG. 6 is a view of the tube of FIG. 2 pre-formed or bent into a second configuration.

FIG. 7 is a view of the pre-formed tube of FIG. 6 shown coupled between a fuel pump and a fuel filter of a fuel delivery module.

FIG. 8 is a side view of FIG. 7 showing the convention tube of FIG. 1 superimposed to indicate a height difference between the pre-formed tube of FIG. 7 and the conventional tube of FIG. 1.

FIG. 9 is a sectional view of a tube for a fuel delivery module provided in accordance with another embodiment of the present invention, showing a cap welded thereto.

### DETAILED DESCRIPTION OF THE EXEMPLARY EMBODIMENTS

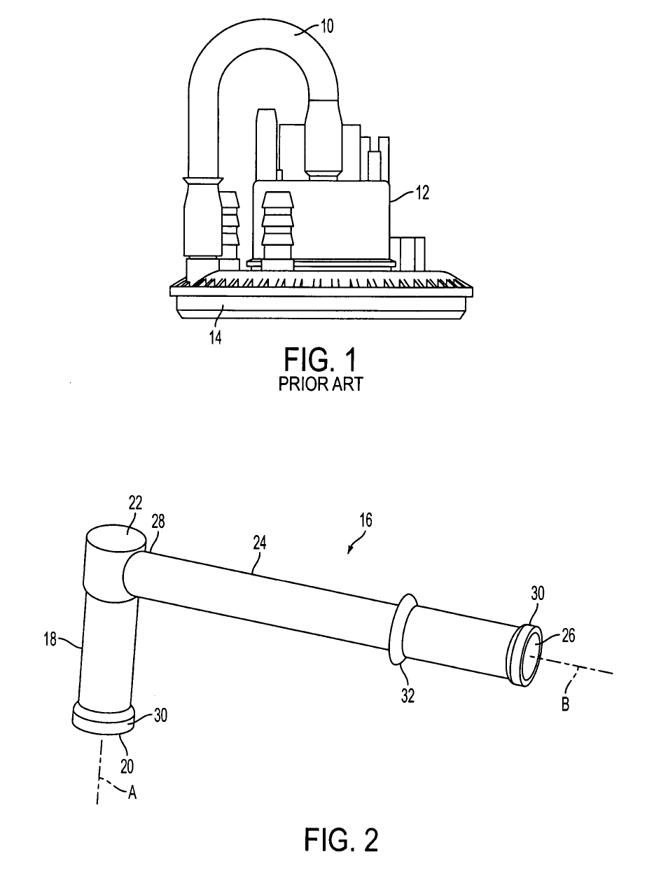

With reference to FIG. 2, a tube for a fuel delivery module of a vehicle is shown generally indicated at 16, in accordance with an embodiment of the invention. The tube 16 is hollow and includes a first portion 18 having an opened end 20 and a closed end 20. The opened end 20 has an axis A. The tube 16 also includes a second portion 24 integral with the first portion 20. The second portion 24 has an opened end 26 and an end 28 coupled with the first portion 18 near end 22 thereof. The opened end 26 of the second portion has an axis B that is generally transverse with respect to axis A (e.g., the tube 16 is of generally L shape) Fuel can thus enter and exit the tube via the communicating opened ends 20 and 26 of the tube 16. Each end 20 and 26 includes a flared portion 30 for ease of aligning and coupling the ends 20, 26 of the tube 16 to associated structures. The tube also includes a flange portion 32 defining an area that can be used to push the tube 16 so that end 26 can seal when engaged with an associated structure such as a filter 14 (see FIG. 4).

To eliminate or reduce the problems associated with the extruded and pre-formed tube 10 of FIG. 1, the tube 16 is molded. In the embodiment, the tube 16 is injection molded from electrically conductive or non-conductive plastic suitable for exposure to fuel such as moldable PA grade. Since the tube 16 is molded, it is easy to change the inside diameter of the tube 16 to ensure proper fuel flow through the tube based on the particular application. The molded tube 16 has an inside diameter less that that of the conventional tube 10 of FIG. 1, thus a smaller bend radius is possible during a pre-forming operation as explained below.

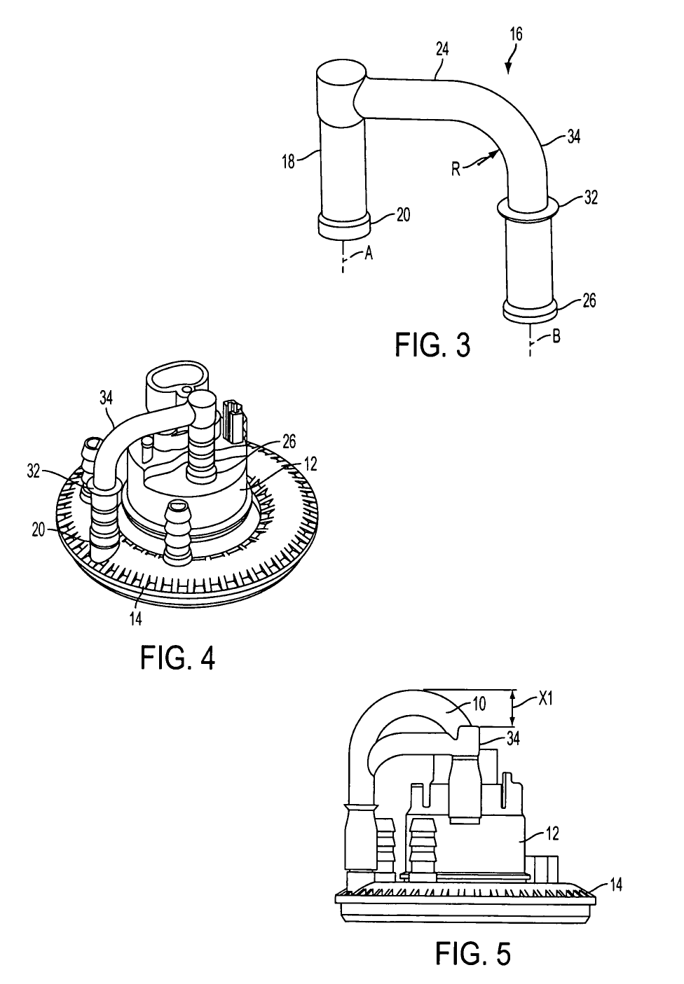

With reference to FIG. 3, the tube 16 is shown after a pre-forming operation to define pre-formed tube 34. In particular, after molding of the tube 16, the second portion 24 is bent at radius R so that axis A and axis B are generally parallel. FIG. 4 shows the pre-formed tube 34 coupled with a filter 14 and a fuel pump 12 of a fuel delivery module of a vehicle. FIG. 5 is a side view of FIG. 4 showing the convention tube 10 of FIG. 1 superimposed to indicate a height difference X1 between pre-formed tube 34 of FIG. 4 and the conventional tube 10 of FIG. 1. In the embodiment X1 is about 11.25 mm. Thus, the tube 34 can be employed in applications with restricted height.

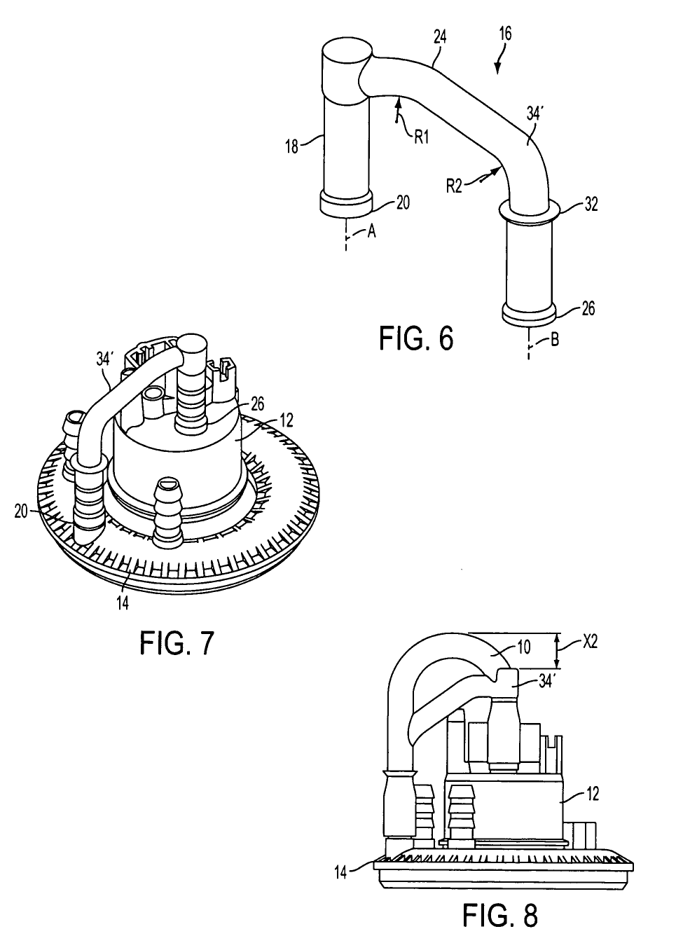

With reference to FIG. 6, the tube 16 is shown after a pre-forming operation to define another pre-formed tube 34′. In particular, after molding of the tube 16, the second portion 24 is bent at a first radius R1 and at a second radius R2 so that axis A and axis B are generally parallel. FIG. 7 shows the pre-formed tube 34′ coupled with a filter 14 and a fuel pump 12 of a fuel delivery module of a vehicle. FIG. 8 is a side view of FIG. 7 showing the convention tube 10 of FIG. 1 superimposed to indicate a height difference X2 between pre-formed tube 34′ of FIG. 7 and the conventional tube 10 of FIG. 1. In the embodiment X2 is about 11.75 mm. Thus, since at least two radii R1 and R2 are defined in the pre-formed tube 34′, the tube 34′ can be employed in applications with even further height restrictions. It can be appreciated that although the terms “radius” or “radii” are used to define R, R1 and R2, the radii R, R1 and R2 do not have to be perfect arc shapes, but define a bend or transition in the second portion 24.

Thus, a method of providing a tube for a fuel delivery module includes molding a hollow tube 16 including a first portion 18 having an axis A and a second portion 24 integral with the first portion 18. The second portion 24 has an axis B such that the axis B of the second portion 24 is generally transverse with respect to the axis A of the first portion 18. Each of the first and second portions has an opened end 20, 26, respectively, with the opened ends communicating with each other. The method further includes pre-forming the tube 16 such that the axis B of the second portion 24 is generally parallel with the axis A of the first portion 18, with the opened ends 20, 26 facing the same direction. The pre-forming step includes creating at least one radius in the second portion. The radius can be provided by heating the tube 16 and then bending the tube 16. The forming process follows known technologies for heat forming tubes, e.g., the tube is pre-heated, then forced into a fixture with the new shape, then run through an oven, then cooled down, ready. The material choice is influenced by the very flat stress/elongation curve of PA; PA can be stretched substantially before it tears apart. This ability to stretch is advantageous if one wants to push a tube onto a barb profile and then seal under high pressure (around 600 kPa operating pressure).

With an injection molded tube 16, one can create 90° (or smaller) bends molded into the tube 16, effectively reducing the total height of the tube. The reason to pre-form the injection molded tube after molding is to be able to realize the flow to turn 180° since this is not currently cost effective to do directly in injection molding. Further injection molding offers a variety of option to configure a dedicated geometry (e.g., flange 32) to push the tube onto the barb geometry in production.

Thus, two low-profile tube configurations can advantageously provided with a single molded tube 16, thereby reducing manufacturing (e.g., mold) costs.

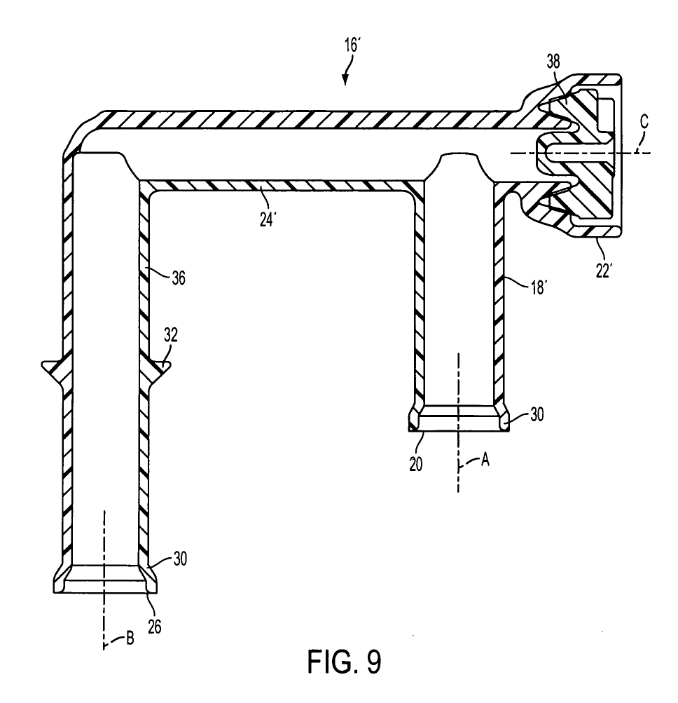

FIG. 9 is a view of a tube 16′ for a fuel delivery module provided in accordance with another embodiment. The tube 16′ is different from that of FIGS. 3 and 6 in that it is molded into its final geometry. Thus, no pre-forming is required. The molded hollow tube 16′ includes a first portion 18′ having an axis A, a second portion 24′ integral with respect to the first portion 18′ and a third portion 36 integral with the second portion 24′ and having an axis B that is generally transverse with respect to the axis A of the first portion 18. An axis C of the second portion is generally transverse with respect to each of axes A and B. Each of the first and third portions has an opened end 20, 26, respectively, with the opened ends communicating with each other via the first, second and third portions of the hollow tube 16′. The second portion 24′ includes an opened end 22′ for ease in molding of the tube 16′. A cap 38 is provided to close the opened end 22′. In the embodiment, the cap 38 is spin welded to end 22′, but other welding techniques can be used to secure the cap 38 to the end 22′

Although the molded tubes 16, 16′ have been disclosed for connection between a filter and a fuel pump of a fuel delivery module, it can be appreciated that the tubes 16, 16′ can be employed for any hydraulic connection in a fuel delivery module.

In summary, a molded tube 16, 16′ offers following advantages versus an extruded and pre-formed tube: 1) molded in pre-flared ends for better tube to barb alignment (manufacturability), 2) molded in geometry to be used for pushing the tube onto barb (manufacturability), 3) better tolerance for tube end to end dimension (manufacturability), 4) better tolerance for tube axis to axis dimension (manufacturability) 5) better tolerance for tube total height dimension (engineering), 6) same tool for conductive or non-conductive tube (cost) smaller packaging height (engineering).

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of providing a tube for a fuel delivery module of a vehicle,
molding a hollow tube to define a first portion and a second portion integral with the first portion, each of the first and second portions having an opened end, with the opened ends communicating with each other, each opened end having an axis, the axis of the opened end of the second portion being generally transverse with respect to the axis of the opened end of the first portion, and
pre-forming the tube such that the axis of the opened end of the second portion is generally parallel with respect to the axis of the opened end of the first portion, with the opened ends facing the same direction.

2. The method of claim 1, wherein the step of molding includes injection molding.

3. The method of claim 1, wherein the step of molding includes providing the ends with flared portions.

4. The method of claim 1, wherein the step of molding includes providing a flange associated with the end of the second portion.

5. The method of claim 1, wherein the step of molding includes molding the tube to be of generally L shape.

6. The method of claim 1, wherein the pre-forming step includes creating at least one bend in the second portion.

7. The method of claim 1, wherein the pre-forming step includes creating at least two bends in the second portion.

8. The method of claim 1, further comprising:
coupling an end of the tube to a fuel filter and coupling the other end of the tube to a fuel pump.

9. A molded hollow tube constructed and arranged to provide a hydraulic connection within a fuel delivery module of a vehicle, the molded tube comprising:
a first portion having an opened first end and a closed second end, the opened first end having an axis, and
a second portion integral with the first portion, the second portion having an opened end and an end coupled with the first portion near the closed second end of the first portion, the opened end of the second portion having an axis, the opened ends being in communication such that fuel can enter and exit the tube via the opened ends,
wherein the second portion includes at least one bend therein such that the axis of the opened end of the second portion is generally parallel with respect to the axis of the opened end of the first portion, with the opened ends facing the same direction.

10. The molded hollow tube of claim 9, wherein the bend is defined by at least one radius.

11. The molded hollow tube of claim 9, wherein the first and second portions are of injection moldable plastic.

12. The molded hollow tube of claim 9, wherein the first and second portions are of injection moldable, electrically conductive plastic.

13. The molded hollow tube of claim 9, wherein flared portions are associated with each opened end.

14. The molded hollow tube of claim 9, wherein the second portion further includes a flange associated with the opened end thereof.

15. The molded hollow tube of claim 9, wherein the bend is defined by at least two radii.

16. The molded hollow tube of claim 9, in combination with a fuel filter and a fuel pump, wherein the opened end of the first portion is coupled to the fuel pump and the opened end of the second portion is coupled to the fuel filter.

17. A method of providing a tube for a fuel delivery module of a vehicle, the method comprising:
molding a hollow tube to define a first portion having a first axis, a second portion integral with the first portion and having a second axis, and a third portion integral with the second portion and having a third axis that is generally transverse with respect to the first axis, the second axis being generally transverse with respect to each of the first and third axes, each of the first and third portions having an opened end that communicate with each other via the first, second and third portions, the second portion including an opened end, and
closing the opened end of the second portion with a cap.

18. The method of claim 17, wherein the step of molding includes injection molding.

19. The method of claim 17, wherein the step of closing includes welding the cap to the opened end of the second portion.

20. The method of claim 17, further comprising:
coupling an end of the tube to a fuel filter and coupling the other end of the tube to a fuel pump.
